(19) United States
(12) Patent Application Publication
(10) Pub. No.: US 2010/0031368 A1
(43) Pub. Date: Feb. 4, 2010

(54) TAMPER DETECTION METHOD AND DATA STORAGE DEVICE USING THE SAME

(76) Inventors: Young Mi Park, Daejeon (KR); Sang Yi Yi, Daejeon (KR); Dae Seon Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/410,812

(22) Filed: Mar. 25, 2009

(30) Foreign Application Priority Data
Jul. 29, 2008 (KR) 10-2008-0074060

(51) Int. Cl. G06F 21/00; G08B 21/00

(52) U.S. Cl. 726/26; 340/540

(57) ABSTRACT

A tamper detection method and a data storage device using the same are provided. The tamper detection method includes sensing a value of pressure applied to a data storage device using a pressure sensor, comparing the sensed pressure value with an initial pressure value sensed at an initial operation time of the data storage device, and detecting malicious tamper by comparing a threshold pressure value varying with the number of loads applied to the data storage device when the sensed pressure value is smaller than the initial pressure value.

### CROSS-REFERENCE TO RELATED APPLICATION

This application claims priority to and the benefit of Korean Patent Application No. 10-2008-0074060, filed on Jul. 29, 2008, the disclosure of which is incorporated herein by reference in its entirety.

### BACKGROUND

1. Field of the Invention

The present invention relates to a tamper detection method and a data storage device using the same, and more particularly, to a tamper detection method capable of more correctly determining whether malicious tamper exists and a data storage device using the same.

2. Discussion of Related Art

With the development of computer storage technology, lightweight data storage devices have been developed. In general, storage devices are used for backup data. However, data storage devices may also be used for storing important data or important system algorithms in a method for maintaining system security by loading an algorithm in a memory, if needed.

Data storage devices for storing important information or important system algorithms should be capable of maintaining security against external attacks, etc.

FIG. 1 conceptually illustrates a conventional tamper detection method used in a data storage device.

A data storage device 101 has various sizes according to storage capacity and its purpose. The data storage device 101 may be a device for storing an algorithm applied to a programmable processor such as a Field Programmable Gate Array (FPGA). Of course, the data storage device 101 may be a Universal Serial Bus (USB) or Personal Computer Memory Card International Association (PCMCIA) storage device for storing general data or a data storage device for security maintenance in any case. For security of the data storage device, a tamper detection method is used to automatically delete data when power is interrupted or when a pressure variation is sensed through a pressure sensor provided in the storage device. A housing surrounding the storage device is usually made of metal or plastic having bending properties. When pressure 103 is repeatedly applied, fatigue degrading housing strength may occur. When the number of pressures applied to the housing increases, a sensed value of the pressure sensor becomes smaller than an initially sensed value. In this case, there is a problem in that malfunction in which data is deleted occurs due to non-malicious tamper.

### SUMMARY OF THE INVENTION

The present invention provides a tamper detection method and a data storage device using the same that can delete data only in the case of malicious tamper by more correctly determining whether pressure is varied by the malicious tamper or housing fatigue.

The present invention also provides a tamper detection method and a data storage device using the same that can delete data only in the case of malicious tamper by modeling a sensed value of a pressure sensor gradually decreasing according to an increase of the number of loads due to housing fatigue and more correctly determining whether a decrease in a value sensed by the pressure sensor is caused by the malicious tamper or housing fatigue.

According to an aspect of the present invention, there is provided a tamper detection method including: sensing a value of pressure applied to a data storage device using a pressure sensor; comparing the sensed pressure value with an initial pressure value sensed at an initial operation time of the data storage device; and detecting malicious tamper by comparing a threshold pressure value varying with the number of loads applied to the data storage device when the sensed pressure value is smaller than the initial pressure value.

The tamper detection method may further include: determining that a decrease in the sensed pressure value is caused by the malicious tamper when the sensed pressure value is out of an error range of the threshold pressure value and deleting memory data. The tamper detection method may further include: determining that a decrease in the sensed pressure value is caused by fatigue of the housing when the sensed pressure value is in an error range of the threshold pressure value and maintaining memory data.

The threshold pressure value may be a sensed value of the pressure sensor gradually decreasing according to an increase in the number of loads by considering fatigue of a material forming the housing surrounding the data storage device modeled after the number of loads. The tamper detection method may further include: increasing the number of loads by one when the sensed pressure value is greater than the initial pressure value. The tamper detection method may further include: deleting memory data when the number of loads is equal to or greater than the number of preset tamper detections. The tamper detection method may further include: deleting memory data when a difference between the sensed pressure value and a preset tamper detection value is in a predetermined error range.

According to another aspect of the present invention, there is provided a data storage device using tamper detection method including: a memory that stores data; a pressure sensor that senses a value of pressure applied to a housing; and a controller than detects malicious tamper by comparing the sensed pressure value with a threshold pressure value varying with the number of loads applied to the housing.

The data storage device using tamper detection method may further include: a real time clock (RTC) that measures an initial operation time of the data storage device and a time of sensing the pressure value, wherein the controller determines whether the sensed pressure value is smaller than an initial pressure value sensed at the initial operation time. When the sensed pressure value is smaller than the initial pressure value and is out of an error range of the threshold pressure value, the controller may determine that a decrease in the sensed pressure value is caused by the malicious tamper and delete the memory data. When the sensed pressure value is smaller than the initial pressure value and is in an error range of the threshold pressure value, the controller may determine that a decrease in the sensed pressure value is caused by fatigue of the housing and maintain the memory data.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 conceptually illustrates a conventional tamper detection method used in a data storage device;

FIG. 2 is a schematic block diagram illustrating a data storage device using tamper detection method according to an exemplary embodiment of the present invention; and

FIG. 3 is a flowchart illustrating a tamper detection method according to an exemplary embodiment of the present invention.

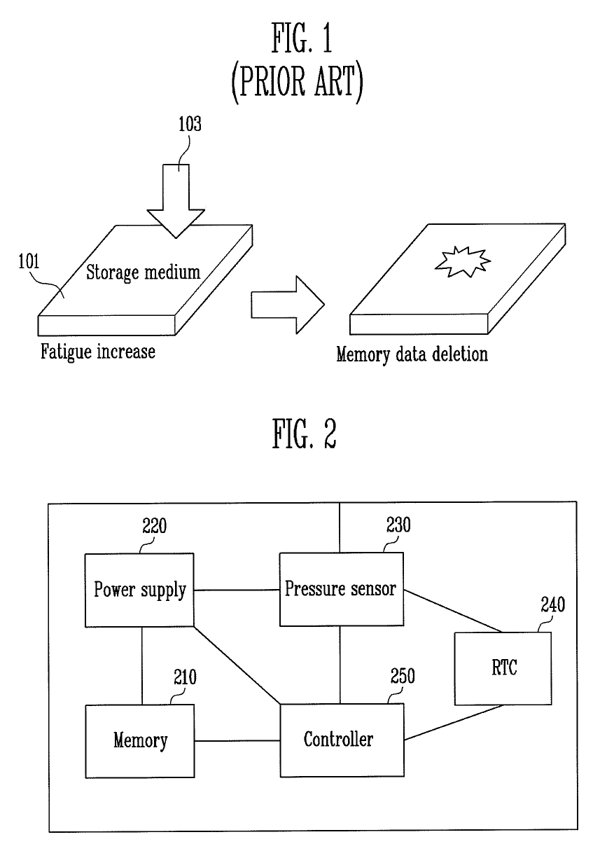

### DETAILED DESCRIPTION OF EXEMPLARY EMBODIMENTS

Hereinafter, a tamper detection method and a data storage device according to exemplary embodiments of the present invention will be described in detail with reference to the accompanying drawings.

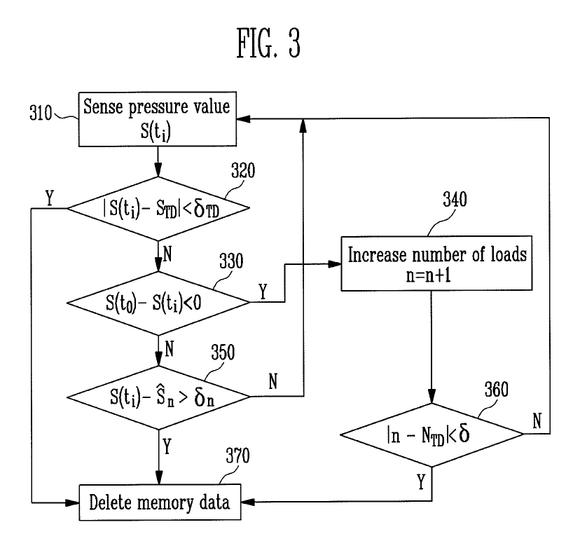

FIG. 2 is a schematic block diagram illustrating a data storage device using tamper detection method according to an exemplary embodiment of the present invention.

Referring to FIG. 2, the data storage device using tamper detection method according to the exemplary embodiment of the present invention includes a memory 210, a power supply 220, a pressure sensor 230, an RTC 240, and a controller 250. These components are surrounded and protected by a housing. In general, the housing may be made of a metal material with bending properties capable of satisfying both strength and lightweight requirements.

The memory 210 for storing data may be used as a volatile memory deleting stored data when power is interrupted or a nonvolatile memory such as a flash memory in which no stored data is deleted even when power is interrupted.

The power supply 220 is responsible for interrupting power or switching power to be supplied to the memory to an external or internal power supply. In general, the power supply 220 includes the internal power supply such as a backup battery. The internal power supply is used to supply power to the data storage device when power is not supplied from an outside source. In an exemplary embodiment of the present invention, the power supply 220 is switched to the internal power supply when the external power supply is in an OFF state, thereby making it possible to continuously sense malicious tamper. The power supply 220 interrupts power after data is deleted from the memory 210 due to the malicious tamper.

The pressure sensor 230 measures a value of pressure applied to the housing in order to sense an open or abnormal state of the housing.

The RTC 240 provides present time information based on a first operation time of the data storage device. That is, when the first operation time is “t₀”, present time information tᵢ is provided. In an exemplary embodiment of the present invention, the present time information provided by the RTC 240 is used to measure the number of loads applied to the housing.

The controller 250, which is a core of the present invention, determines whether the malicious tamper occurs by comparing a sensed value of the pressure sensor 230 with a threshold pressure value given by modeling a sensed value gradually decreasing according to an increase in the number of loads applied to the housing, and deletes data from the memory 210 when the malicious tamper occurs.

The threshold pressure value is a value obtained by modeling a sensed value of the pressure sensor varying with the number of loads when pressure is applied to the housing through experimentation with a stress-number of cycle (SN) curve. The threshold pressure value is stored in an internal memory (not shown) within the controller 250. When the number of loads increases due to the effect of fatigue in which metal strength is degraded by repeated loads, the sensed value of the pressure sensor 230 is smaller than an initially sensed value of the data storage device. Accordingly, a sensed value modeled according to the number of loads considering the metal fatigue is set to the threshold pressure value, such that whether the decrease in the sensed value of the pressure sensor 230 is caused by the malicious tamper or metal fatigue can be more correctly determined.

The controller 250 compares the sensed value of the pressure sensor 230 with a preset tamper detection value. When a difference between the sensed value and the preset tamper detection value is in an error range, the controller 250 determines that the housing is opened and deletes data from the memory 210. At this time, the tamper detection value is preset to a value sensible by the pressure sensor when the housing is opened.

When a value sensed by the pressure sensor 230 based on the present time information tᵢ provided from the RTC 240 is greater than an initially sensed value, the controller 250 determines that pressure is applied to the housing and increases the number of loads. When a difference between the number of loads and the preset number of tamper detections is in an error range, the controller 250 can delete data from the memory 210. Since the effect of housing fatigue increases when the number of loads is equal to or greater than the preset number of tamper detections, the controller 250 can determine that malicious tamper is no longer correctly detected and issue a command to delete the data from the memory 210. When the memory 210 is a volatile memory, the controller 250 commands the power supply 220 to interrupt power to be supplied to the memory 210. When the memory 210 is a nonvolatile memory, the controller 250 directly commands the memory 210 to delete the data.

FIG. 3 is a flowchart illustrating a tamper detection method according to an exemplary embodiment of the present invention.

Referring to FIG. 3, a pressure value S(tᵢ) applied to the housing at a present time tᵢ is sensed using the pressure sensor (step 310). In an exemplary embodiment, present time information can be provided by the RTC.

Next, the presently sensed value S(tᵢ) is compared with a preset tamper detection value S_{TD} in step 320. Upon determining that a difference between the presently sensed value S(tᵢ) and the tamper detection value S_{TD} is in an error range δ_{TD}, memory data is deleted and power is interrupted (step 370). As described above, since the tamper detection value S_{TD} is a sensed value when the housing is opened, the memory data is deleted when the difference between the presently sensed value S(tᵢ) and the tamper detection value S_{TD} is in the error range δ_{TD}.

Otherwise, the presently sensed value S(tᵢ) is compared with an initially sensed value S(t₀) in step 330. Upon determining that S(tᵢ)>S(t₀), it is determined that a load is applied to the housing and the number of loads, n, is increased in step 340.

In step 360, it is determined whether the increased number of loads is in an error range of the preset number of tamper detections, N_{TD}. If the number of loads is equal to or greater than the number of tamper detections, it means that the housing fatigue increases by repeated loads. In this case, malicious tamper is no longer correctly detected and therefore memory data is deleted in step 370.

When the presently sensed value S(tᵢ) is smaller than the initially sensed value S(t₀) in a comparison result of step 330, it should be determined whether the decrease in the sensed value is caused by the malicious tamper or metal fatigue. For this, the presently sensed value S(tᵢ) is compared with a threshold pressure value Ŝₙ modeled after the number of loads considering the housing fatigue in step 350. When the presently sensed value S(tᵢ) is in an error range δₙ of the threshold pressure value Ŝₙ, it is determined that the decrease in the sensed value is caused by the metal fatigue and step 310 is performed.

However, when the presently sensed value S(tᵢ) is out of the error range δₙ of the threshold pressure value Ŝₙ, is determined that the decrease in the sensed value is caused by the malicious tamper. In this case, the memory data is deleted and the power is interrupted in step 370.

A tamper detection method proposed in the present invention can more correctly distinguish between a pressure variation caused by malicious tamper and a pressure variation caused by housing fatigue and more stably protect data by deleting data of a data storage device only when the malicious tamper occurs.

While the present invention has been shown and described in connection with exemplary embodiments thereof, it will be apparent to those skilled in the art that modifications and variations can be made without departing from the spirit and scope of the invention as defined by the appended claims.

What is claimed is:

1. A tamper detection method comprising:
sensing a value of pressure applied to a data storage device using a pressure sensor;
comparing the sensed pressure value with an initial pressure value sensed at an initial operation time of the data storage device; and
detecting malicious tamper by comparing a threshold pressure value varying with the number of loads applied to the data storage device when the sensed pressure value is smaller than the initial pressure value.

2. The tamper detection method of claim 1, further comprising:
determining that a decrease in the sensed pressure value is caused by the malicious tamper when the sensed pressure value is out of an error range of the threshold pressure value and deleting memory data.

3. The tamper detection method of claim 1, further comprising:
determining that a decrease in the sensed pressure value is caused by fatigue of the housing when the sensed pressure value is in an error range of the threshold pressure value and maintaining memory data.

4. The tamper detection method of claim 1, wherein the threshold pressure value is a sensed value of the pressure sensor gradually decreasing according to an increase in the number of loads by considering fatigue of a material forming the housing surrounding the data storage device modeled after the number of loads.

5. The tamper detection method of claim 1, further comprising: increasing the number of loads by one when the sensed pressure value is greater than the initial pressure value;
deleting memory data when the number of loads is equal to or greater than the number of preset tamper detections.

6. The tamper detection method of claim 1, further comprising:
deleting memory data when a difference between the sensed pressure value and a preset tamper detection value is in a predetermined error range.

7. A data storage device using tamper detection method comprising:
a memory that stores data;
a pressure sensor that senses a value of pressure applied to a housing; and
a controller that detects malicious tamper by comparing the sensed pressure value with a threshold pressure value varying with the number of loads applied to the housing.
